(19) United States
(12) Patent Application Publication
(10) Pub. No.: US 2026/0153821 A1
(43) Pub. Date: Jun. 4, 2026

(54) FIXING DEVICE AND IMAGE FORMING APPARATUS

(71) Applicant: FUJIFILM BUSINESS INNOVATION CORP., Tokyo (JP)

(72) Inventors: Yasushi FUJIWARA, Kanagawa (JP); Motoyuki Yagi, Kanagawa (JP); Taisei Seo, Kanagawa (JP); Noriaki Kishi, Kanagawa (JP)

(73) Assignee: FUJIFILM BUSINESS INNOVATION CORP., Tokyo (JP)

(21) Appl. No.: 19/188,700

(22) Filed: Apr. 24, 2025

(30) Foreign Application Priority Data
Nov. 29, 2024 (JP) 2024-207960

(51) Int. Cl. G03G 15/20

(52) U.S. Cl. CPC G03G 15/2053; G03G 15/2064; G03G 2215/2038

(57) ABSTRACT

A fixing device includes a rotatable body including a heat source; a tubular belt to be rotated while being in contact with an outer peripheral surface of the rotatable body; a counter member provided on an inner peripheral side of the belt and having a counter surface that faces toward the outer peripheral surface of the rotatable body; a raised portion provided as a portion of the counter surface and raised at an end of the counter surface, the end being on a downstream side in a rotation direction of the rotatable body, the raised portion being configured to press the belt against the outer peripheral surface of the rotatable body in such a manner as to form a downstream nip; and an elastic member attached to the counter surface while being in contact with a lateral face of the raised portion, the elastic member being configured to press the belt against the outer peripheral surface of the rotatable body in such a manner as to form an upstream nip, in which a pressure to be generated at the upstream nip continuously increases from an upstream-side end to a downstream-side end of the upstream nip in the rotation direction.

### CROSS-REFERENCE TO RELATED APPLICATIONS

This application is based on and claims priority under 35 USC 119 from Japanese Patent Application No. 2024-207960 filed November 29, 2024.

### BACKGROUND

### Technical Field

The present disclosure relates to a fixing device and an image forming apparatus.

### Related Art

A fixing device disclosed in Japanese Unexamined Patent Application Publication No. 2004-184476 (Claim 1, paragraphs 0016 to 0017, and FIGS. 1 and 3) is configured to nip a transfer material at a nip part and thus fix an unfixed toner image on the transfer material under heat and pressure.

The nip part of the above fixing device includes a high-pressure portion and a low-pressure portion. The pressure at the high-pressure portion is higher than a preset threshold. The pressure at the low-pressure portion is lower than the preset threshold.

In the above fixing device, the ratio of areas of the high-pressure portion and the low-pressure portion is variable.

A fixing device disclosed in Japanese Unexamined Patent Application Publication No. 2011-81224 (Claim 1, and FIGS. 2 to 4) includes a heating unit, a pressure-contact unit, and a pressing unit.

The pressure-contact unit is configured to cooperate with the heating unit to form a nip part where a sheet is pressed into contact with the heating unit. The pressing unit is configured to apply a pressurizing force to the sheet through the pressure-contact unit and thus form the nip part between the heating unit and the pressure-contact unit.

The pressing unit is configured to apply a higher pressure to upstream and downstream portions of the nip part in a sheet transporting direction than to a central portion of the nip part. Furthermore, the pressing unit is configured to apply a higher pressure to the downstream portion of the nip part than to the upstream portion.

### SUMMARY

Aspects of non-limiting embodiments of the present disclosure relate to a fixing device in which a sheet passing through an upstream nip and a downstream nip is less likely to have wrinkles than in a case where the pressure to be generated at the upstream nip does not continuously increase from the upstream-side end to the downstream-side end of the upstream nip in the direction of rotation of a rotatable body.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including a rotatable body including a heat source; a tubular belt to be rotated while being in contact with an outer peripheral surface of the rotatable body; a counter member provided on an inner peripheral side of the belt and having a counter surface that faces toward the outer peripheral surface of the rotatable body; a raised portion provided as a portion of the counter surface and raised at an end of the counter surface, the end being on a downstream side in a rotation direction of the rotatable body, the raised portion being configured to press the belt against the outer peripheral surface of the rotatable body in such a manner as to form a downstream nip; and an elastic member attached to the counter surface while being in contact with a lateral face of the raised portion, the elastic member being configured to press the belt against the outer peripheral surface of the rotatable body in such a manner as to form an upstream nip, wherein a pressure to be generated at the upstream nip continuously increases from an upstream-side end to a downstream-side end of the upstream nip in the rotation direction.

### BRIEF DESCRIPTION OF THE DRAWINGS

Exemplary embodiments of the present disclosure will be described in detail based on the following figures, wherein:

FIG. 1 is an overview of an image forming apparatus including a fixing device according to a first exemplary embodiment;

FIG. 2 is a schematic sectional view of the fixing device according to the first exemplary embodiment, illustrating a configuration common to a second exemplary embodiment;

FIG. 3 is an enlarged schematic sectional view of a part of the fixing device according to the first exemplary embodiment;

FIG. 4A is a schematic sectional view of a counter member included in the fixing device illustrated in FIG. 3;

FIG. 4B is a schematic perspective view of a part of the counter member illustrated in FIG. 4A;

FIG. 5A is a schematic sectional view of the counter member and an elastic member included in the fixing device illustrated in FIG. 3;

FIG. 5B schematically illustrates a state of an upstream nip formed by the counter member and the elastic member illustrated in FIG. 5A;

FIG. 6 is a graph illustrating a pressure distribution over the upstream nip and a downstream nip formed in the fixing device illustrated in FIG. 3 and others;

FIG. 7 is an enlarged schematic sectional view of a part of a fixing device according to the second exemplary embodiment;

FIG. 8A is a schematic sectional view of a counter member and an elastic member included in the fixing device illustrated in FIG. 7;

FIG. 8B schematically illustrates a state of an upstream nip formed by the counter member and the elastic member illustrated in FIG. 8A;

FIG. 9A is an enlarged schematic sectional view of a part of a comparative fixing device;

FIG. 9B is a schematic sectional view of a counter member and an elastic member included in the fixing device illustrated in FIG. 9A; and

FIG. 10 is a graph illustrating a pressure distribution over an upstream nip and a downstream nip formed in the fixing device illustrated in FIG. 9.

### DETAILED DESCRIPTION

Exemplary embodiments of the present disclosure will now be described.

### First Exemplary Embodiment

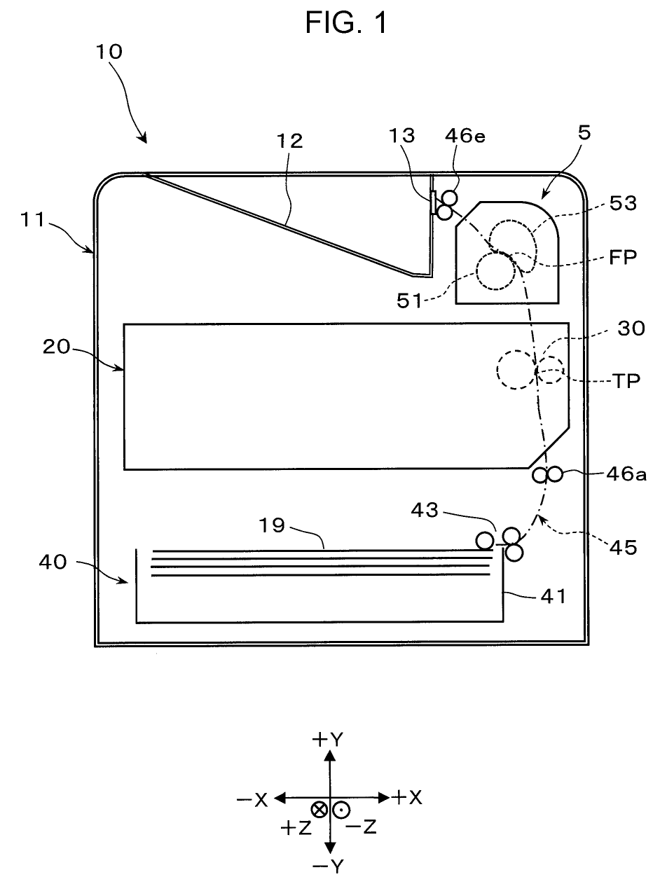

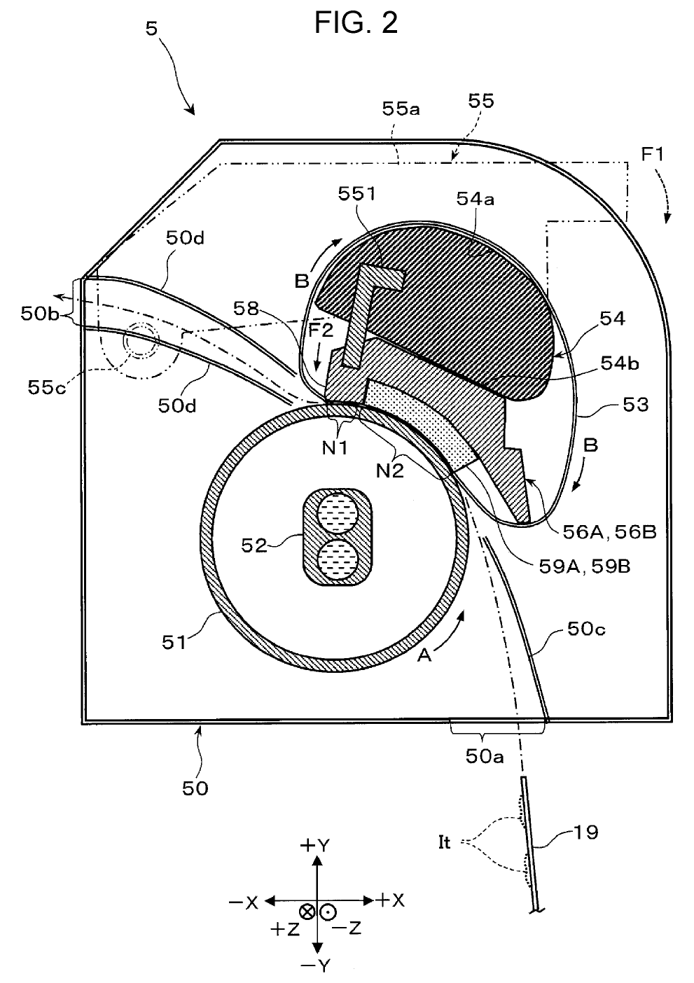

FIG. 1 illustrates an image forming apparatus 10, which includes a fixing device 5 according to a first exemplary embodiment. FIG. 2 illustrates the fixing device 5 according to the first exemplary embodiment.

In this specification and the drawings, elements that are substantially the same are denoted by the same reference signs. In this specification, redundant description of substantially the same elements is omitted.

In FIG. 1 and others, reference signs +X and -X denote the rightward direction and the leftward direction, respectively, of the image forming apparatus 10 and other relevant elements in front view. Reference signs +Y and -Y denote the upward direction and the downward direction, respectively, of the image forming apparatus 10 and other relevant elements. Reference signs +Z and -Z denote the far side and the near side, respectively, in the depthwise direction of the image forming apparatus 10 and other relevant elements in front view.

In FIG. 1 and others, the circle with a cross represents the direction from the near side toward the far side relative to the plane of the page in the drawings. Furthermore, the circle with a dot represents the direction from the far side toward the near side relative to the plane of the page in the drawings.

### 1 Image Forming Apparatus

The image forming apparatus 10 is configured to form a predetermined image on a sheet 19. The image is any expression that contains visible information such as text, diagrams, photographs, and patterns.

The image forming apparatus 10 has an internal space defined by a housing 11. An imaging device 20, a sheet feeding device 40, the fixing device 5, and other relevant elements are provided in the internal space.

Furthermore, a power feeding device, a rotary driving device, a control device, and so forth (not illustrated) are provided in the internal space of the housing 11. An operation panel and so forth (not illustrated) are provided on the outer side of the housing 11.

The housing 11 is a box-like structure having an external shape and the internal space that are predetermined.

The housing 11 is constituted by, for example, frames, plates, exterior members, and so forth.

The housing 11 has at the top thereof an output accommodation part 12, which is configured to receive and accommodate any sheets 19 each having an image formed thereon. A portion of the output accommodation part 12 that forms a side face has an output port 13, which allows the sheet 19 to pass through to be outputted.

The imaging device 20 is capable of forming an unfixed image on a sheet 19.

The imaging device 20 employs, for example, an electrophotographic imaging scheme.

The imaging device 20 in such a case includes an image carrier, a charging device, an image exposure device, a developing device, a transfer device, a cleaning device, and so forth (not illustrated). The imaging device 20 may be either a device configured to form a monochrome (black, for example) image or a device configured to form a multicolor (color) image.

The image carrier is a rotatable structure, such as a photoconductor drum, having an image-carrying surface on which an image is to be carried. The charging device is configured to charge the image-carrying surface of the image carrier.

The image exposure device is configured to form an electrostatic latent image by performing exposure on the charged image-carrying surface of the image carrier in accordance with image information. The image information relates to an image that is inputted to the image forming apparatus 10 from an external device or the like.

The developing device is configured to develop with a developer the electrostatic latent image formed on the image-carrying surface of the image carrier into an unfixed image. The unfixed image is, for example, a toner image obtained through the development.

The transfer device is configured to transfer the unfixed image formed on the image carrier to a sheet 19.

The transfer device employs a direct transfer scheme or an intermediate transfer scheme. The direct transfer scheme is intended to directly transfer an unfixed image to a sheet 19. The intermediate transfer scheme is intended to transfer an unfixed image to an intermediate transfer body in a first transfer process and then to a sheet 19 in a second transfer process.

In FIG. 1, a part configured to transfer an unfixed image to a sheet 19 is illustrated as a transfer part 30. The transfer part 30 has a transfer position TP, where a sheet 19 is made to pass so that an unfixed image is transferred thereto.

The cleaning device is configured to clean the image-carrying surface of the image carrier and/or the image-carrying surface of the intermediate transfer body.

The sheet feeding device 40 is configured to accommodate predetermined sheets 19 and to feed each of the sheets 19 to the imaging device 20.

The sheet feeding device 40 includes an accommodation member 41, which is configured to accommodate sheets 19; and a delivering device 43, which is configured to deliver the sheets 19 one by one from the accommodation member 41. The accommodation member 41 and the delivering device 43, which are provided in one pair in FIG. 1, may be provided in multiple pairs.

The sheets 19 are each a recording medium that is transportable in the housing 11 and is handleable by the imaging device 20 in operations such as the transfer of an unfixed image. The sheet 19 may be any sheet-type recording medium having a predetermined size.

The fixing device 5 is configured to fix the unfixed image formed by the imaging device 20 to the sheet 19.

The fixing device 5 has a fixing housing 50, in which a heating roll 51, a belt 53, and other relevant elements are provided. The heating roll 51 is an exemplary rotatable body provided for heating. The belt 53 is an exemplary rotatable body provided for pressing.

In the fixing device 5, a part where the heating roll 51 and the belt 53 are in contact with each other is defined as a fixing position FP, where the sheet 19 is made to pass for a fixing operation.

Details of the fixing device 5 will be described separately below.

A sheet transport path 45 runs through the internal space of the housing 11 and is illustrated by a one-dot chain line in FIG. 1 and others.

The sheet transport path 45 includes a transport path extending from the sheet feeding device 40 through the imaging device 20 and the fixing device 5 to the output port 13. The transport path is intended to transport the sheet 19 through the transfer position TP defined in the imaging device 20 and the fixing position FP defined in the fixing device 5.

The sheet transport path 45 is constituted by a predetermined number of pairs of transporting rolls 46a and 46e and other relevant elements (not illustrated) such as transport guiding members.

### 2 Image Forming Operation

The image forming apparatus 10 is configured to perform the following image forming operation.

The following description is based on an assumption that the imaging device 20 forms a monochrome image.

When the control device (not illustrated) of the image forming apparatus 10 receives a command for an image forming operation, the imaging device 20, the sheet feeding device 40, the fixing device 5, and other relevant elements are activated.

Accordingly, the image carrier of the imaging device 20 starts to rotate in a predetermined direction. In the imaging device 20, the rotating image carrier undergoes a charging operation, an exposure operation, a development operation, a transfer operation, and a cleaning operation.

Meanwhile, in the sheet feeding device 40 and the sheet transport path 45, a sheet feeding operation is performed synchronously with the transfer operation.

Thus, in the imaging device 20, an unfixed image is formed on the image carrier. The transfer part 30 of the imaging device 20 receives a predetermined sheet 19 delivered from the sheet feeding device 40 along the sheet transport path 45.

In the imaging device 20, the unfixed image on the image carrier is transferred to the sheet 19 at the transfer position TP defined in the transfer part 30.

In the fixing device 5, the heating roll 51 and the belt 53 start to rotate. Furthermore, in the fixing device 5, the heating roll 51 is heated to a temperature that enables a fixing operation.

In the fixing device 5, after the heating roll 51 reaches the temperature that enables the fixing operation, the fixing operation is performed.

In the fixing device 5, the sheet 19 having the unfixed image transferred thereto is introduced into the fixing housing 50 and is made to pass through the fixing position FP.

Thus, in the fixing device 5, the unfixed image on the sheet 19 is heated under pressure when passing through the fixing position FP and is fixed to the sheet 19.

Lastly, in the image forming apparatus 10, the sheet 19 having undergone the fixing operation in the fixing device 5 is transported along the sheet transport path 45 to the output port 13.

Then, the sheet 19 having undergone the fixing operation is outputted from the output port 13 by the pair of transporting rolls 46e and is accommodated by the output accommodation part 12.

Through the above series of operations, a basic image forming operation of forming an image on one side of one sheet 19 is complete.

### 3 Fixing Device

The fixing device 5 has the fixing housing 50 (see FIG. 2).

The fixing device 5 includes inside the fixing housing 50 the heating roll 51, the belt 53, a counter member 56A, an elastic member 59A, and so forth.

The fixing housing 50 is a box-like structure having an external shape and an internal space that are predetermined.

The fixing housing 50 has an inlet 50a and an outlet 50b for the sheet 19.

In the internal space of the fixing housing 50 are provided an introduction guiding member 50c, a discharge guiding member 50d, and so forth. Inside the fixing housing 50 is further provided a temperature sensor or the like (not illustrated) configured to detect the surface temperature of the heating roll 51.

The fixing housing 50 is fixed at a predetermined position in the housing 11 of the image forming apparatus 10.

The heating roll 51 is a structure including a circular cylindrical roll base that is made of metal or the like; and any relevant layers, such as a release layer, provided on the outer peripheral surface of the roll base.

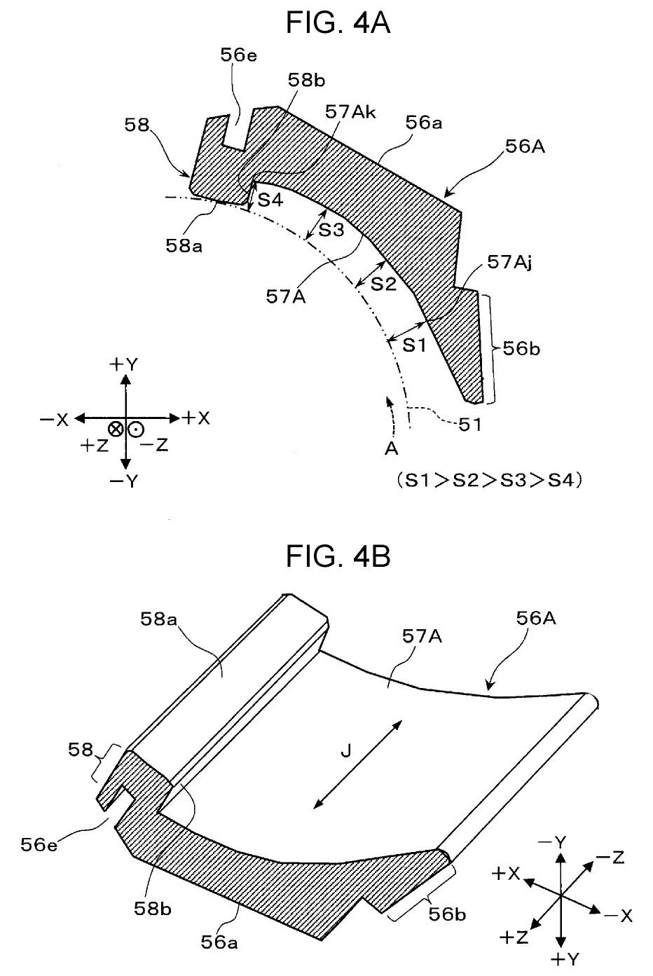

The heating roll 51 is rotatably attached to the fixing housing 50 with the aid of bearings or the like provided at two respective ends, in an axial direction J (see FIG. 4B), of the heating roll 51. The axial direction J is parallel to the depthwise direction Z of the image forming apparatus 10.

A receiving gear (not illustrated) is provided at the far-side end of the heating roll 51 in the axial direction J. Power generated by a rotary driving device (not illustrated) is to be transmitted to the receiving gear. When the fixing operation and other relevant operations are started, the heating roll 51 is rotated in a rotation direction A.

The heating roll 51 has an internal space in which a halogen heater lamp 52 is provided. The halogen heater lamp 52 is an exemplary heat source.

The halogen heater lamp 52 is fixedly provided in the internal space of the heating roll 51 and extends parallel to the axial direction J of the heating roll 51.

The halogen heater lamp 52 is configured to generate heat by receiving a predetermined electric power from a power feeding device (not illustrated) and thus heat the heating roll 51.

The belt 53 is a tubular member that is to be rotated while being in contact with the outer peripheral surface of the heating roll 51.

A member employed as the belt 53 includes a cylindrical belt base and any relevant layers provided on the outer peripheral surface of the belt base. The belt base is made of polyimide resin or the like. Examples of the relevant layers include a heat-resistant release layer.

The belt 53 is rotatably held by a belt holding member 54, the counter member 56A, the elastic member 59A, and other relevant elements that are provided on the inner peripheral side thereof.

The belt holding member 54 provided on the inner peripheral side of the belt 53 extends parallel to the axial direction J of the heating roll 51.

The belt holding member 54 has a belt holding surface 54a and a pressing surface 54b (see FIG. 2).

The belt holding surface 54a is a curved surface at which the inner peripheral surface of the belt 53 is slidably held from below. The pressing surface 54b is a substantially flat surface that is in contact with a portion of the counter member 56A and at which the counter member 56A is to be pressed. The portion of the counter member 56A serves as a pressure receiving surface 56a, to be described below.

The belt holding member 54 is attached to a pressing mechanism 55 with the aid of a supporting member 551 (see FIG. 2).

The supporting member 551 supports the belt holding member 54 and is configured to transmit a pressing effect produced by the pressing mechanism 55 to the belt holding member 54.

The supporting member 551 is a plate extending parallel to the axial direction J of the heating roll 51.

The supporting member 551 according to the first exemplary embodiment is a metal plate whose upper portion is bent.

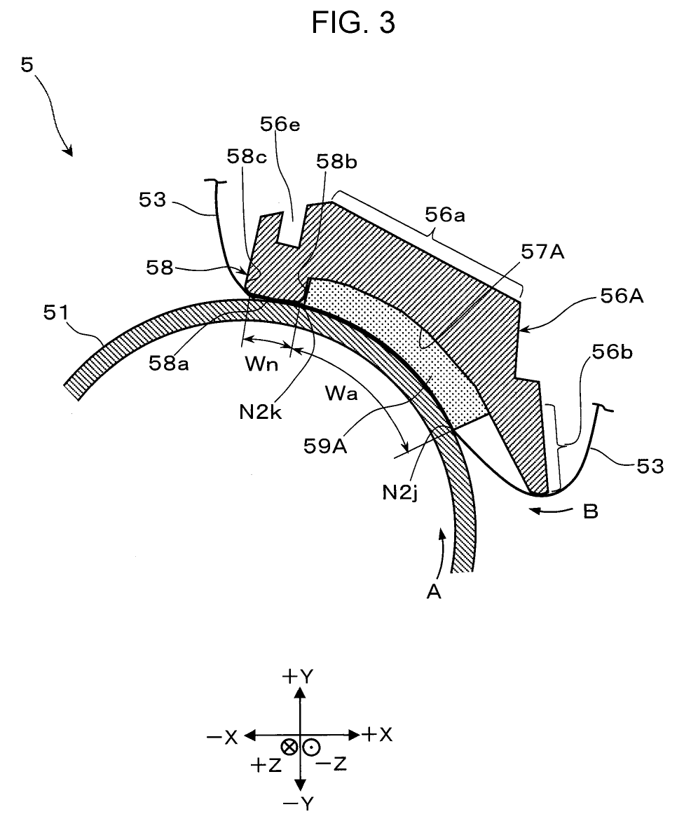

The supporting member 551 is fixed such that the bent upper portion thereof is present inside the belt holding member 54. A lower portion (lower end portion) of the supporting member 551 is fitted in an insertion groove 56e (see FIG. 3), which is provided in the counter member 56A.

Two ends of the supporting member 551 in the long-side direction thereof are attached to respective swing arms 55a, which are included in the pressing mechanism 55 and will be described below.

The pressing mechanism 55 includes the swing arms 55a and other relevant elements (not illustrated) such as a pressing component.

The swing arms 55a are swingable about a supporting shaft 55c. The two ends of the supporting member 551 are attached to the respective swing arms 55a. The swing arms 55a are a pair of arms each extending over a corresponding one of the ends of the heating roll 51 from above. The supporting shaft 55c is fixed to, for example, a portion of the fixing housing 50.

The pressing component is configured to apply a predetermined pressure F1 (see FIG. 2) to the swing arms 55a such that the swing arms 55a swing toward the heating roll 51. The pressing component is any one or combination of a tension spring, a compression spring, a cam, and so forth.

The belt holding member 54 receives the predetermined pressure F1 from the pressing mechanism 55 through the supporting member 551.

Accordingly, the pressing surface 54b of the belt holding member 54 comes into contact with and is pressed against the pressure receiving surface 56a of the counter member 56A. The supporting member 551 in such a state directly transmits the pressing effect from the pressing mechanism 55 to the insertion groove 56e of the counter member 56A.

Thus, the belt holding member 54 cooperates with the supporting member 551 to press the counter member 56A toward the heating roll 51.

The counter member 56A is located on the inner peripheral side of the belt 53 and faces toward the outer peripheral surface of the heating roll 51.

The counter member 56A is a plate-like member having a raised portion 58 and a counter surface 57A. The counter member 56A is also shaped to have the pressure receiving surface 56a, a belt guiding portion 56b, and the insertion groove 56e.

The counter member 56A is obtained by, for example, molding of synthetic resin or the like.

Two ends of the counter member 56A in the long-side direction thereof are attached to the fixing housing 50 and are displaceable relative to the fixing housing 50. That is, the counter member 56A is displaceable in a direction in which the counter surface 57A and the raised portion 58 are brought toward and away from the outer peripheral surface of the heating roll 51.

The raised portion 58 of the counter member 56A is a portion of the counter surface 57A that is raised at an end of the counter surface 57A on the downstream side in the rotation direction A of the heating roll 51.

The raised portion 58 is configured to press the belt 53 against the outer peripheral surface of the heating roll 51 in such a manner as to form a downstream nip N1 (see FIG. 2). The nip refers to a contact part that is formed under pressure.

The raised portion 58 is raised from the counter surface 57A of the counter member 56A toward the heating roll 51 by a predetermined height.

The raised portion 58 extends parallel to the axial direction J of the heating roll 51.

The raised portion 58 has a substantially rectangular sectional shape.

The raised portion 58 has a top face 58a, an upstream lateral face 58b, a downstream lateral face 58c, and so forth.

The top face 58a forms a surface at which the belt 53 is pressed against the outer peripheral surface of the heating roll 51 and at which the downstream nip N1 is formed. The top face 58a forms a curved surface that is convex toward the raised side of the raised portion 58. The top face 58a of the raised portion 58 comes into contact with the heating roll 51 over an area having a nip width Wn (see FIG. 3) in the rotation direction A of the heating roll 51, thereby forming the downstream nip N1.

The upstream lateral face 58b extends from the upstream end of the top face 58a to the counter surface 57A. The downstream lateral face 58c extends from the downstream end of the top face 58a to the downstream-side end of the counter member 56A.

The counter surface 57A of the counter member 56A faces toward the outer peripheral surface of the heating roll 51 with a predetermined gap S in between.

The counter surface 57A extends from the raised portion 58 of the counter member 56A toward the upstream side in the rotation direction A of the heating roll 51.

The counter surface 57A is a curved surface that curves substantially in conformity with the outer peripheral surface of the heating roll 51.

The pressure receiving surface 56a of the counter member 56A is a surface with which the pressing surface 54b of the belt holding member 54 is in contact.

In the counter member 56A, the pressure receiving surface 56a is located opposite the counter surface 57A. The pressure receiving surface 56a is a flat surface that is facing substantially parallel to the pressing surface 54b of the belt holding member 54.

The belt guiding portion 56b of the counter member 56A is to guide the rotating belt 53 such that the belt 53 is brought close to the heating roll 51 at a predetermined position.

The belt guiding portion 56b extends toward the upstream side in the rotation direction A beyond a portion of the counter surface 57A where the elastic member 59A is attached.

Thus, the belt guiding portion 56b guides the belt 53 such that a portion of the belt 53 that has passed the belt holding member 54 is brought close to the heating roll 51. Specifically, the belt 53 thus guided is brought close to the heating roll 51 at a position before an upstream nip N2, which will be described separately below.

The insertion groove 56e provided in the counter member 56A is a groove in which a lower portion of the above-described supporting member 551 is fitted.

The insertion groove 56e is provided in a portion of the counter member 56A that is located opposite the raised portion 58. The insertion groove 56e extends linearly and parallel to the axial direction J of the heating roll 51. That is, the positions of the insertion groove 56e and the raised portion 58 match each other at the front and back sides, respectively, of the counter member 56A.

The elastic member 59A is an elastically deformable member that is attached to the counter surface 57A of the counter member 56A.

The elastic member 59A is also configured to press the belt 53 against the outer peripheral surface of the heating roll 51 in such a manner as to form the upstream nip N2 (see FIG. 2).

The elastic member 59A is a plate-like member whose section is substantially rectangular with a thickness (height) and a width Wa, which are predetermined, and extends to a predetermined length.

The elastic member 59A is oriented with the long-side direction thereof being parallel to the axial direction J of the heating roll 51.

The width Wa of the elastic member 59A refers to a dimension in the rotation direction A of the heating roll 51 (see FIG. 3). The width Wa of the elastic member 59A is set to a dimension that corresponds to the width of the upstream nip N2.

The elastic member 59A is made of an elastic material such as silicon sponge.

The elastic member 59A is attached to the counter surface 57A of the counter member 56A with double-faced adhesive tape, an adhesive agent, or the like.

One end of the elastic member 59A thus attached is in contact with the upstream lateral face 58b of the raised portion 58 (see FIG. 3).

In the fixing device 5, the pressing mechanism 55 performs a pressing operation, whereby the counter member 56A receives a pressing effect from the belt holding member 54 and the supporting member 551.

That is, in the fixing device 5, the pressure F1 generated by the pressing mechanism 55 is transmitted to the counter member 56A through the belt holding member 54 and the supporting member 551.

Thus, in the fixing device 5, the counter member 56A is subjected to a pressure acting in such a direction as to bring the counter member 56A close to the outer peripheral surface of the heating roll 51.

In such a state, the raised portion 58 of the counter member 56A is kept being pressed against the outer peripheral surface of the heating roll 51 with the belt 53 in between.

The raised portion 58 in the above state is pressed substantially by the supporting member 551.

Thus, the raised portion 58 is pressed against the outer peripheral surface of the heating roll 51 with a predetermined pressure F2 (see FIG. 2).

Consequently, the raised portion 58 forms the downstream nip N1 at the outer peripheral surface of the heating roll 51 with the belt 53 in between. The downstream nip N1 formed by the raised portion 58 has the nip width Wn.

The downstream nip N1 is regarded as a site where the raised portion 58 substantially applies the pressure F2 to the sheet 19 and the unfixed image over an area having the nip width Wn.

In such a state, the elastic member 59A is kept being pressed against the outer peripheral surface of the heating roll 51 with the belt 53 in between.

In other words, the elastic member 59A is pressed against the outer peripheral surface of the heating roll 51 by the counter surface 57A of the counter member 56A.

Accordingly, the elastic member 59A is elastically deformed while being pressed against the outer peripheral surface of the heating roll 51 with the belt 53 in between.

That is, when in use, the elastic member 59A has a thickness smaller than before the fixing device 5 is assembled (when under no load).

Consequently, the elastic member 59A forms the upstream nip N2 at the outer peripheral surface of the heating roll 51 with the belt 53 in between. The upstream nip N2 thus formed has a nip width substantially equal to the width Wa of the elastic member 59A.

The upstream nip N2 is formed by the elastically deformable elastic member 59A. That is, the upstream nip N2 is regarded as a site where a pressure lower than the pressure F2 for the downstream nip N1 is applied to the sheet 19 and the unfixed image.

The nip width (substantially the width Wa) of the upstream nip N2 is greater than the nip width Wn of the downstream nip N1. The nip width of the upstream nip N2 may be set to, for example, a dimension greater than or equal to three times the nip width Wn of the downstream nip N1. That is, the upstream nip N2 is regarded as a site where heat and a low pressure are applied to the sheet 19 and the unfixed image for a longer period than at the downstream nip N1.

### 4 Fixing Operation

When the fixing device 5 receives a command for a fixing operation, the heating roll 51 starts to rotate in the rotation direction A.

Accordingly, the belt 53 receives a rotational force from the heating roll 51 at the upstream nip N2 and the downstream nip N1 and rotates in a direction B by following the heating roll 51. The belt 53 thus rotating is held by the belt holding member 54 and is guided by the belt guiding portion 56b of the counter member 56A. The belt 53 thus rotating moves in a circular manner while being in contact with the outer peripheral surface of the heating roll 51 and passing through the upstream nip N2 and the downstream nip N1.

In such a state, the heating roll 51 is heated to a predetermined temperature under a heat generating operation of the halogen heater lamp 52. The heating roll 51 thus heated makes the upstream nip N2 and the downstream nip N1 through which the belt 53 passes be ready for a heating process.

When the fixing device 5 becomes ready for the fixing operation, a sheet 19 having an unfixed image It (see FIG. 2) transferred thereto is introduced into the fixing housing 50.

The sheet 19 when introduced is oriented such that the side having the transferred unfixed image It faces the heating roll 51.

Furthermore, the sheet 19 when introduced is guided by the introduction guiding member 50c and moves to a position where the heating roll 51 and the belt 53 start to come into contact with each other.

Then, the sheet 19 is transported while being nipped between the heating roll 51 and the belt 53 that are rotating.

Specifically, the sheet 19 thus transported passes through the upstream nip N2 and the downstream nip N1 in that order.

Accordingly, the sheet 19 having the transferred unfixed image It is heated under pressure while passing through the upstream nip N2 and the downstream nip N1.

Consequently, the unfixed image It is fused with the heat and is fixed to the sheet 19.

In this process, the unfixed image It and the sheet 19 receive a relatively low pressure at the upstream nip N2. Subsequently, the unfixed image It and the sheet 19 receives a relatively high pressure (F2) at the downstream nip N1.

That is, the fixing device 5 firstly performs a preliminary fixing process at the upstream nip N2, and secondly performs a finishing fixing process at the downstream nip N1.

When the fixing operation ends in the fixing device 5, the sheet 19 is guided by the discharge guiding member 50d and is discharged to the outside of the fixing housing 50.

The sheet 19 to be discharged is released from the heating roll 51 after passing through the downstream nip N1.

Through the above series of processes, a fixing operation that is performed on one sheet 19 by the fixing device 5 is complete.

### 5 Problems

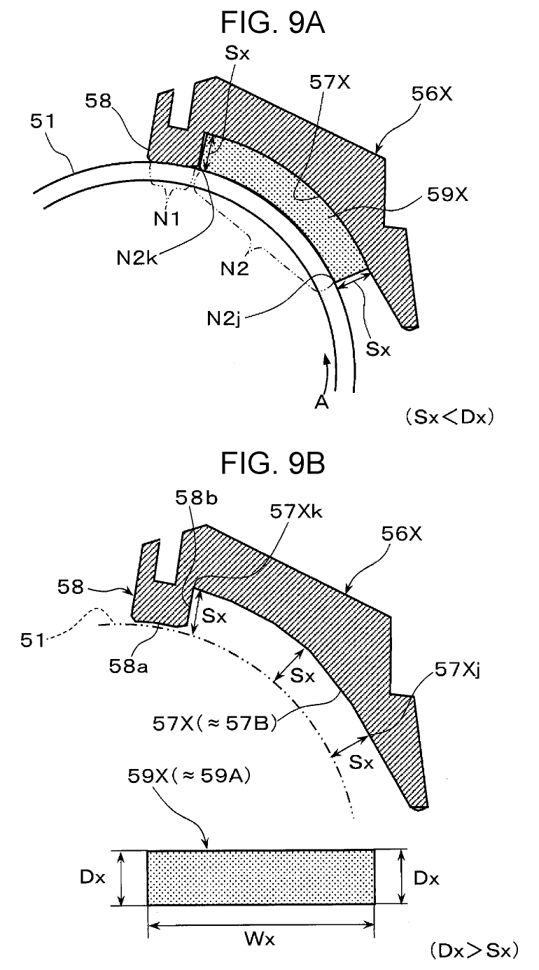

FIG. 9A illustrates a comparative fixing device. The comparative fixing device may involve the following problems.

The comparative fixing device employs a counter member 56X and an elastic member 59X illustrated in FIG. 9B.

The counter member 56X has a counter surface 57X illustrated in FIG. 9B. The counter surface 57X is at a gap Sx with respect to the outer peripheral surface of the heating roll 51. The gap Sx is constant from an upstream end 57Xj to a downstream end 57Xk in the rotation direction A.

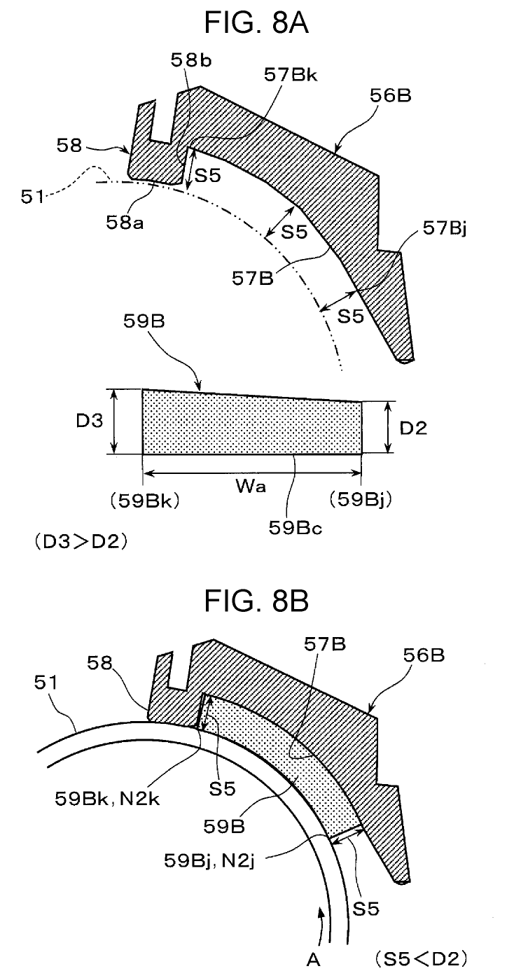

Note that the counter surface 57X is substantially equivalent to a counter surface 57B of a counter member 56B according to a second exemplary embodiment to be described below. The constant gap Sx for the counter surface 57X may be either equal to or different from a constant gap S5, which is set for the below-described counter surface 57B (see FIG. 8A).

The elastic member 59X is a plate-like member having a thickness Dx and a width Wx, which are constant as illustrated in FIG. 9B.

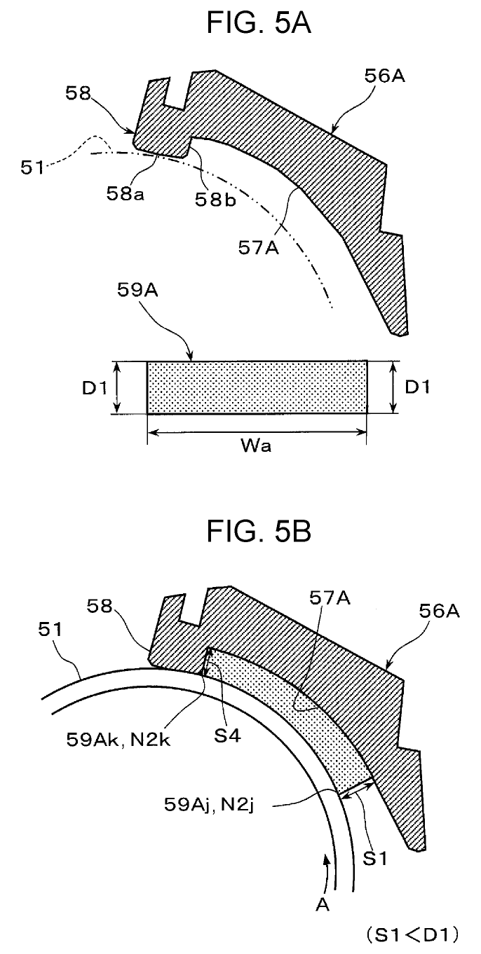

Note that the elastic member 59X is substantially equivalent to the elastic member 59A according to the first exemplary embodiment. The constant thickness Dx and width Wx of the elastic member 59X may be either equal to or different from below-described constant thickness D1 and width Wa (see FIG. 5A) of the elastic member 59A.

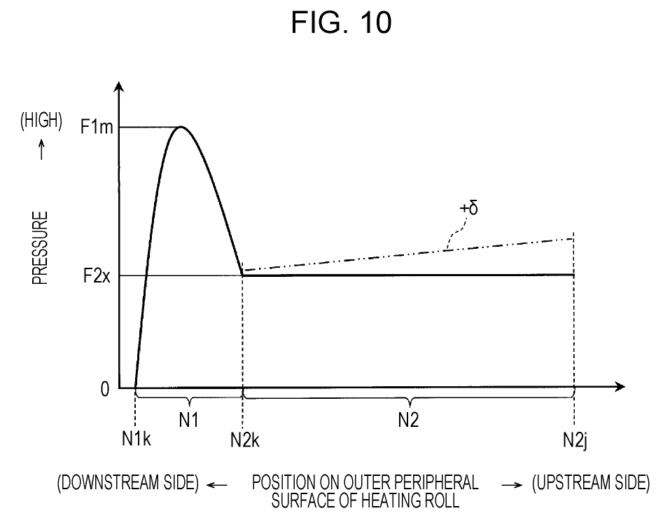

Accordingly, in the comparative fixing device, the pressure at the upstream nip N2 is as illustrated in FIG. 10. Specifically, the pressure at the upstream nip N2 is constant from an upstream-side end N2j to a downstream-side end N2k in the rotation direction A.

In FIG. 10, reference sign F2x denotes the constant pressure at the upstream nip N2. In FIG. 10 and others, reference sign F1m denotes the maximum pressure at the downstream nip N1. In FIG. 10 and others, reference sign N1k denotes (the position of) the downstream-side end of the downstream nip N1.

In the comparative fixing device, however, the upstream nip N2 may exhibit an unexpected pressure distribution as represented by two-dot chain line +δ in FIG. 10.

In the unexpected pressure distribution, the pressure tends to gradually decrease from the upstream-side end N2j to the downstream-side end N2k.

In the unexpected pressure distribution, the pressure at the upstream-side end N2j is higher than the pressure at the downstream-side end N2k. The unexpected pressure distribution tends to occur because of the tolerances of relevant components, variations in the accuracy of assembly, and so forth.

In the fixing device exhibiting such an unexpected pressure distribution, the sheet 19 having passed through the upstream nip N2 and the downstream nip N1 tends to have wrinkles.

One cause for such wrinkles is presumed to be the fluctuation in the pressure applied to the sheet 19 while the sheet 19 is passing through the upstream nip N2 and the downstream nip N1. In the above fluctuation, the pressure first decreases and then increases. It is presumed that such a pressure fluctuation causes the speed of transport of the sheet 19 to partially fluctuate and thus causes the sheet 19 to expand and contract in the direction of transport.

### 6 Additional Configuration of Fixing Device

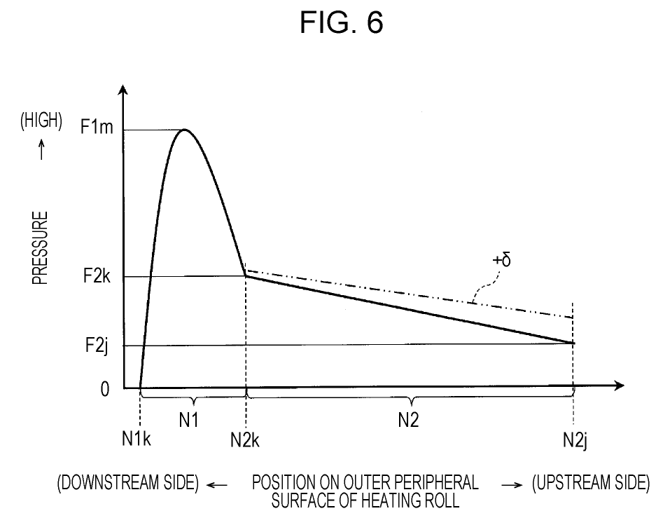

In view of the above, the fixing device 5 is configured such that the pressure at the upstream nip N2 increases as represented by a solid line in FIG. 6.

Specifically, the pressure at the upstream nip N2 continuously increases from the upstream-side end N2j to the downstream-side end N2k.

Accordingly, the upstream nip N2 is regarded as a site where the pressure continuously and monotonously increases from the upstream-side end N2j to the downstream-side end N2k. The pressure graphed in FIG. 6 and others is also referred to as a pressurizing force.

The pressure at the upstream nip N2 may increase at a constant rate.

The pressure, F2j, at the upstream-side end N2j of the upstream nip N2 and the above constant rate of increase may be set in any way.

The difference between the pressure F2j at the upstream-side end N2j of the upstream nip N2 and the pressure, F2k, at the downstream-side end N2k of the upstream nip N2 are set as follows.

The difference is set such that the pressure F2j at the upstream-side end N2j does not exceed the pressure F2k at the downstream-side end N2k even if the above unexpected pressure distribution occurs at the upstream nip N2.

Thus, even if the unexpected pressure distribution occurs at the upstream nip N2, there is no chance that the upstream pressure F2j may exceed the downstream pressure F2k. The unexpected pressure distribution in such a configuration is represented by two-dot chain line +δ in FIG. 6.

The pressure F2k at the downstream-side end N2k of the upstream nip N2 may be set within the following range.

Specifically, the pressure F2k may be set within a range of 0 ≤ F2k ≤ 0.5·F1m, where F1m denotes the maximum pressure at the downstream nip N1.

The counter member 56A and the elastic member 59A that are employed in the fixing device 5 are configured as follows.

The counter member 56A employs the counter surface 57A extending such that the gap S with respect to the outer peripheral surface of the heating roll 51 is continuously reduced from the upstream end to the downstream end thereof in the rotation direction A.

In FIG. 4A, four gaps S1, S2, S3, and S4 are illustrated as representative gaps S for the counter surface 57A.

The gap S1 is set for the upstream end, 57Aj, of the counter surface 57A. The gap S4 is set for the downstream end, 57Ak, of the counter surface 57A. The gaps S2 and S3 are set for two respective points where the area between the upstream end 57Aj and the downstream end 57Ak of the counter surface 57A is divided into three equal parts.

The gaps S1, S2, S3, and S4 are in a size relationship of S1 > S2 > S3 > S4. Specifically, the gaps become smaller at a constant rate of reduction.

As illustrated in FIG. 5A, the elastic member 59A has a constant thickness D1. The elastic member 59A has the width Wa as described above.

The constant thickness D1 of the elastic member 59A is a dimension greater than the gap S1 at the upstream end 57Aj of the counter surface 57A.

The elastic member 59A having the constant thickness D1 is attached to the counter surface 57A of the counter member 56A for which the above gaps S are set.

When the fixing device 5 is assembled, the elastic member 59A is pressed against the outer peripheral surface of the heating roll 51 with the belt 53 in between.

Accordingly, the elastic member 59A is kept in an elastically deformed state.

Furthermore, the elastic member 59A presses the belt 53 against the outer peripheral surface of the heating roll 51, thereby forming the upstream nip N2.

In such a configuration, the upstream-side end N2j of the upstream nip N2 is formed substantially by the upstream end, 59Aj, of the elastic member 59A (see FIG. 5B). On the other hand, the downstream-side end N2k of the upstream nip N2 is formed substantially by the downstream end, 59Ak, of the elastic member 59A (see FIG. 5B).

In such a state, the amount of elastic deformation of the elastic member 59A is smallest in the gap S1 at the upstream end 57Aj of the counter surface 57A.

On the other hand, the amount of elastic deformation of the elastic member 59A is greatest in the gap S4 at the downstream end 57Ak of the counter surface 57A.

In the fixing device 5 according to the first exemplary embodiment, the pressure at the upstream nip N2 continuously increases from the upstream-side end N2j to the downstream-side end N2k (see FIG. 6).

Therefore, in the fixing device 5, the pressure applied to the sheet 19 does not fluctuate in a decreasing manner or multiple times while passing through at least the upstream nip N2.

### Second Exemplary Embodiment

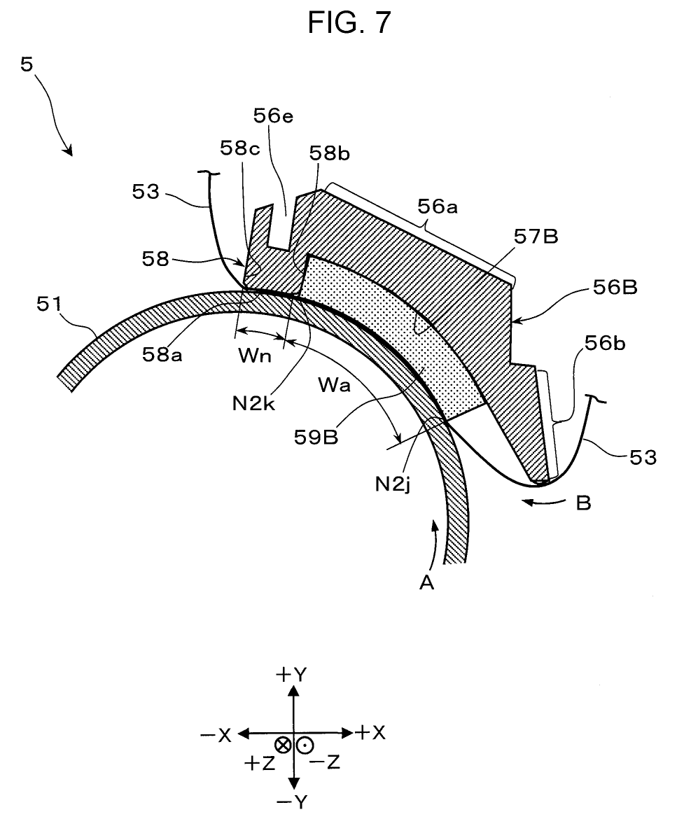

FIG. 7 illustrates a part of a fixing device 5 according to a second exemplary embodiment.

The fixing device 5 according to the second exemplary embodiment is different from the fixing device 5 according to the first exemplary embodiment in including a counter member 56B and an elastic member 59B. Other details of the fixing device 5 are the same between the first and second exemplary embodiments.

The counter member 56B has a counter surface 57B, which is at a gap S with respect to the outer peripheral surface of the heating roll 51. The gap S is constant from an upstream end 57Bj to a downstream end 57Bk in the rotation direction A.

In FIG. 8A, three gaps S5, S5, and S5 are illustrated as representative gaps S for the counter surface 57B. The upstreammost one of the gaps S5 is set for the upstream end, 57Bj, of the counter surface 57B. The downstream most one of the gaps S5 is set for the downstream end, 57Bk, of the counter surface 57B.

The three gaps S5, S5, and S5 are of the same size.

Note that the gaps S5 may be either equal to or different from the gap S1 (see FIG. 4A) for the counter surface 57A according to the first exemplary embodiment.

The elastic member 59B has a thickness D that continuously increases from the upstream end 59Bj to the downstream end 59Bk (see FIG. 8A) in the rotation direction A. The elastic member 59B has the width Wa, as with the case of the elastic member 59A according to the first exemplary embodiment.

The elastic member 59B has a smallest thickness D2 at the upstream end 59Bj, and a greatest thickness D3 at the downstream end 59Bk. The thickness D of the elastic member 59B monotonously increases from the upstream end 59Bj to the downstream end 59Bk.

The upstream-end thickness D2 of the elastic member 59B is a dimension greater than the gap S5 at the upstream end of the counter surface 57B.

The elastic member 59B has a sectional shape of a trapezoid that is laid on its side.

The elastic member 59B having the continuously increasing thickness D is attached to the counter surface 57B of the counter member 56B for which the constant gaps S5 are set. Specifically, the elastic member 59B is attached such that, for example, the lower surface, 59Bc (see FIG. 8A), thereof that is not inclined is brought into contact with the counter surface 57B.

When the fixing device 5 is assembled, the elastic member 59B is pressed against the outer peripheral surface of the heating roll 51 with the belt 53 in between.

Thus, the elastic member 59B is kept in an elastically deformed state.

Furthermore, the elastic member 59B presses the belt 53 against the outer peripheral surface of the heating roll 51, thereby forming the upstream nip N2.

In such a configuration, the upstream-side end N2j of the upstream nip N2 is formed substantially by the upstream end 59Bj of the elastic member 59B (see FIG. 8B). On the other hand, the downstream-side end N2k of the upstream nip N2 is formed substantially by the downstream end 59Bk of the elastic member 59B (see FIG. 8B).

In such a state, the amount of elastic deformation of the elastic member 59B is smallest at the upstream end 59Bj having the thickness D2.

On the other hand, the amount of elastic deformation of the elastic member 59B is greatest at the downstream end 59Bk having the thickness D3.

In the fixing device 5 according to the second exemplary embodiment as well, the pressure at the upstream nip N2 continuously increases from the upstream-side end N2j to the downstream-side end N2k (see FIG. 6).

### Variations

The present disclosure is not limited to the first and second exemplary embodiments described above. The present disclosure may be changed according to need, unless the essence of the present disclosure that are disclosed in Summary are changed.

Specifically, the present disclosure encompasses the following variations.

The halogen heater lamp 52 serving as the heat source included in the heating roll 51 may be replaced with any other heat source. Examples of the heat source include a heat-generating resistance layer, an electromagnetic induction-heating layer, and an external heating device.

The heating roll 51 of the fixing device 5 may be replaced with a rotatable body in the form of a belt that is intended for heating and is supported by multiple rolls.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

### 1

A fixing device comprising:

a rotatable body including a heat source;

a tubular belt to be rotated while being in contact with an outer peripheral surface of the rotatable body;

a counter member provided on an inner peripheral side of the belt and having a counter surface that faces toward the outer peripheral surface of the rotatable body;

a raised portion provided as a portion of the counter surface and raised at an end of the counter surface, the end being on a downstream side in a rotation direction of the rotatable body, the raised portion being configured to press the belt against the outer peripheral surface of the rotatable body in such a manner as to form a downstream nip; and

an elastic member attached to the counter surface while being in contact with a lateral face of the raised portion, the elastic member being configured to press the belt against the outer peripheral surface of the rotatable body in such a manner as to form an upstream nip,

wherein a pressure to be generated at the upstream nip continuously increases from an upstream-side end to a downstream-side end of the upstream nip in the rotation direction.

### 2

The fixing device according to (((1))),

wherein a pressure at the downstream-side end of the upstream nip is close to a pressure at the downstream nip.

### 3

The fixing device according to (((1))) or (((2))),

wherein a gap between the counter surface and the outer peripheral surface of the rotatable body is continuously reduced from an upstream end to a downstream end of the counter surface in the rotation direction, and

wherein the elastic member has a constant thickness and is kept elastically deformed while being pressed by the counter surface against the outer peripheral surface of the rotatable body with the belt in between.

### 4

The fixing device according to (((1))) or (((2))),

wherein a gap between the counter surface and the outer peripheral surface of the rotatable body is constant from an upstream end to a downstream end of the counter surface in the rotation direction, and

wherein the elastic member has a thickness that continuously increases from an upstream end to a downstream end of the elastic member in the rotation direction, the elastic member being kept elastically deformed while being pressed by the counter surface against the outer peripheral surface of the rotatable body with the belt in between.

### 5

An image forming apparatus comprising the fixing device according to any one of (((1))) to (((4))).

What is claimed is:

1. A fixing device comprising:
a rotatable body including a heat source;
a tubular belt to be rotated while being in contact with an outer peripheral surface of the rotatable body;
a counter member provided on an inner peripheral side of the belt and having a counter surface that faces toward the outer peripheral surface of the rotatable body;
a raised portion provided as a portion of the counter surface and raised at an end of the counter surface, the end being on a downstream side in a rotation direction of the rotatable body, the raised portion being configured to press the belt against the outer peripheral surface of the rotatable body in such a manner as to form a downstream nip; and
an elastic member attached to the counter surface while being in contact with a lateral face of the raised portion, the elastic member being configured to press the belt against the outer peripheral surface of the rotatable body in such a manner as to form an upstream nip,
wherein a pressure to be generated at the upstream nip continuously increases from an upstream-side end to a downstream-side end of the upstream nip in the rotation direction.

2. The fixing device according to claim 1,
wherein a pressure at the downstream-side end of the upstream nip is close to a pressure at the downstream nip.

3. The fixing device according to claim 1,
wherein a gap between the counter surface and the outer peripheral surface of the rotatable body is continuously reduced from an upstream end to a downstream end of the counter surface in the rotation direction, and
wherein the elastic member has a constant thickness and is kept elastically deformed while being pressed by the counter surface against the outer peripheral surface of the rotatable body with the belt in between.

4. The fixing device according to claim 1,
wherein a gap between the counter surface and the outer peripheral surface of the rotatable body is constant from an upstream end to a downstream end of the counter surface in the rotation direction, and
wherein the elastic member has a thickness that continuously increases from an upstream end to a downstream end of the elastic member in the rotation direction, the elastic member being kept elastically deformed while being pressed by the counter surface against the outer peripheral surface of the rotatable body with the belt in between.

5. An image forming apparatus comprising the fixing device according to claim 1.

6. An image forming apparatus comprising the fixing device according to claim 2.

7. An image forming apparatus comprising the fixing device according to claim 3.

8. An image forming apparatus comprising the fixing device according to claim 4.
